(19) United States
(12) Patent Application Publication
(10) Pub. No.: US 2008/0263523 A1
(43) Pub. Date: Oct. 23, 2008

(54) Method for testing engineering software

(76) Inventor: Rupert Fruth, Sinzing (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 12/148,117

(22) Filed: Apr. 16, 2008

(30) Foreign Application Priority Data
Apr. 19, 2007 (DE) 10 2007 018 637.3

(51) Int. Cl. G06F 9/44

(52) U.S. Cl. 717/126

(57) ABSTRACT

There is described a method for testing engineering software for at least one switching device, with the engineering software being installed on a computer with at least one interface, with a first interface being provided for communication between the engineering software and switching device. To significantly reduce the software development time, it is proposed for information relating to the switching device to be input into simulation software, for the simulation software to communicate with the engineering software by way of the first interface and for the simulation software to simulate the behavior of the switching device with the aid of the information.

### CROSS REFERENCE TO RELATED APPLICATIONS

This application claims priority of German application No. 10 2007 018 637.3 DE filed Apr. 19, 2007, which is incorporated by reference herein in its entirety.

The invention relates to a method for testing engineering software for at least one switching device, with the engineering software being installed on a computer with at least one interface, with a first interface being provided for communication between the engineering software and switching device.

### BACKGROUND OF INVENTION

A method of this type is used in the development of a new engineering software. Significant development steps consist here in the examination, documentation and creation of demo versions of the relevant software, which is used to configure at least one switching device.

Previously, a completely developed switching device had to be provided for this, in other words the software developers had to wait until the switching device was present.

### SUMMARY OF INVENTION

An object underlying the invention is to specify a method, with which the software development time can be significantly reduced.

This object is achieved with a method of the type mentioned in the introduction such that information relating to the switching device is input into simulation software, the simulation software communicates with the engineering software by way of the first interface and the simulation software simulates the behavior of the switching device with the aid of the information.

In this way, the (device) simulation software of the engineering software (parameterizing and diagnosis software) on the computer simulates a real switching device such as for instance an engine starter with the aid of information and/or descriptions (device descriptions, data records, logic, initialization). As a result, engineering software and simulation software are also able to run on the same computer if the computer has more than one interface, with the simulation software responding by way of a second interface, which is connected to the first interface, by way of which the engineering software expects to communicate with the switching device.

The method significantly reduces the software development time, test time and documentation time, since the software developer testing the engineering software no longer has to wait for the finished switching device.

In an advantageous form of the embodiment, a device bus, in particular RS232, PROFIBUS or PROFFNET, is connected to the first interface for communication purposes. The simulation software communicates in this way with the engineering software by way of a device bus, by way of which the engineering software would also communicate with a real switching device.

In a further advantageous embodiment, the engineering software and the simulation software are controlled by means of a test automation software in order to automatically test the engineering software with the aid of test patterns, random generators and/or device descriptions. The control is advantageously carried out here by way of a standard tool such as for instance IBM Rational Robot or Microsoft Visual Test. In this way, the test automation software can be installed on the same one as both or one of the two programs to be controlled, in other words engineering software or simulation software. If one or both of the programs to be controlled is installed on a different computer than the test automation software, the control can take place by way of any network connection. The software examinations and examination documentation can thus be almost full automated, whereas in the past software examinations had for the most part to be undertaken manually. In addition, the test intensity improves and the tests can be reproduced.

In a further advantageous embodiment, the characteristics of the tests of the dialogs between the engineering software and the simulation software are automatically examined and documented. The communication between the engineering software and simulation software which is controlled by the test automation software is herewith monitored.

### BRIEF DESCRIPTION OF THE DRAWINGS

The invention is described and explained in more detail below, with reference to the exemplary embodiments illustrated in the Figures, in which:

FIG. 1 shows a schematic representation of an exemplary embodiment, in which engineering software and simulation software are installed on the same computer,

FIG. 2 shows an exemplary embodiment with test automation software, in which the simulation software is installed on a second computer.

### DETAILED DESCRIPTION OF INVENTION

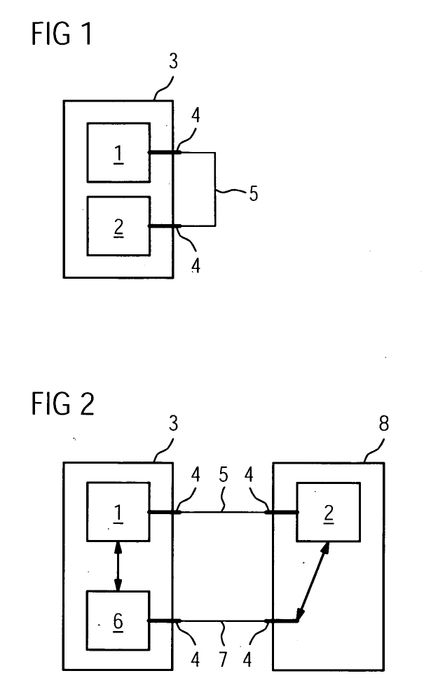

FIG. 1 shows engineering software 1 and simulation software 2, which are both installed on the same computer 3. The computer has two interfaces 4, with the upper showing a first interface 4 in the figure, by way of which the engineering software 1 expects communication with a switching device. To this end, the simulation software 2 is connected to the first interface 4 by way of the second, lower interface with a device bus 5. Information, such as for instance device descriptions or data records, was input into the simulation software 2 by way of the switching device to be simulated, so that the engineering software 1 notices no difference from communication with a real switching device. In this way, the engineering software 1 can already be tested during the course of its development, even if the real switching device itself still has yet to be completely developed, as a result of which the development times reduce considerably.

FIG. 2 shows engineering software 1, which is installed on a first computer 3, and simulation software 2, which is installed on a second computer 8. Each of the two computers 3, 8 has two interfaces 4, with an upper interface 4 of the first computer 3 such as shown in FIG. 11, wherein the upper interface 4 is a first interface 4, by way of which the engineering software 11 expects communication with a switching device. This first interface 4 is connected to the simulation software 2 by way of a device bus 5. Test automation software 6 is also installed on the first computer 3, and is connected to a further, lower, interface 4 of the second computer 8 by way of a second interface 4, once again the lower in the figure, and any network connection 7. This test automation software 6 controls, advantageously by way of a standard tool such as for instance IBM Rational Robot or Microsoft Visual Test, both the engineering software 1 as well as the simulation software 2 with the aid of test patterns, random generators and device descriptions for instance. The software examinations and the examination documentation can herewith be almost completely automated. Furthermore, the test intensity improves and the tests can be reproduced.

In summary, the invention relates to a method for testing engineering software for at least one switching device. The engineering software is installed on a computer with at least one interface, with a first interface being provided for communication between engineering software and switching device. To significantly reduce the software development time, it is proposed that information relating to the switching device be input into simulation software such that the simulation software communicates with the engineering software by way of the first interface and the simulation software simulates the behavior of the switching device with the aid of the information.

1.-4. (canceled)

5. A method for testing engineering software, comprising:
providing a switching device;
providing a computer, wherein the engineering software is installed on the computer, wherein the computer has at least one interface, and wherein the simulation software communicates with the engineering software via the interface;
using the interface for a communication between the engineering software and the switching device;
inputting information related to the switching device into the simulation software; and
simulating the behavior of the switching device based upon the information using the simulation software.

6. The method as claimed in claim 5, wherein with a device bus is connected to the interface for the communication.

7. The method as claimed in claim 5, wherein with a RS232 bus is connected to the interface for the communication.

8. The method as claimed in claim 5, wherein with a PROFIBUS is connected to the interface for the communication.

9. The method as claimed in claim 5, wherein with a PROFINET-Bus is connected to the interface for the communication.

10. The method as claimed in claim 5, wherein the engineering software and the simulation software are controlled based upon a test automation software to test automatically the engineering software and based upon test patterns.

11. The method as claimed in claim 10, wherein the engineering software and the simulation software are controlled based upon a test automation software to test automatically the engineering software and based upon random generators.

12. The method as claimed in claim 11, wherein the engineering software and the simulation software are controlled based upon a test automation software to test automatically the engineering software and based upon device descriptions.

13. The method as claimed in claim 5, wherein the engineering software and the simulation software are controlled based upon a test automation software to test automatically the engineering software and based upon random generators.

14. The method as claimed in claim 13, wherein the engineering software and the simulation software are controlled based upon a test automation software to test automatically the engineering software and based upon device descriptions.

15. The method as claimed in claim 5, wherein the engineering software and the simulation software are controlled based upon a test automation software to test automatically the engineering software and based upon device descriptions.

16. The method as claimed in claim 10, wherein characteristics of the tests of dialogs between the engineering software and the simulation software are automatically examined and documented.

17. The method as claimed in claim 11, wherein characteristics of the tests of dialogs between the engineering software and the simulation software are automatically examined and documented.

18. The method as claimed in claim 12, wherein characteristics of the tests of dialogs between the engineering software and the simulation software are automatically examined and documented.

19. The method as claimed in claim 13, wherein characteristics of the tests of dialogs between the engineering software and the simulation software are automatically examined and documented.

20. The method as claimed in claim 14, wherein characteristics of the tests of dialogs between the engineering software and the simulation software are automatically examined and documented.

21. The method as claimed in claim 15, wherein characteristics of the tests of dialogs between the engineering software and the simulation software are automatically examined and documented.
